(19) United States
(12) Patent Application Publication
(10) Pub. No.: US 2026/0149141 A1
(43) Pub. Date: May 28, 2026

(54) REFERENCE ELECTRODES, ELECTROCHEMICAL DEVICES INCLUDING REFERENCE ELECTRODES, AND METHODS OF MAKING REFERENCE ELECTRODES

(71) Applicant: GM GLOBAL TECHNOLOGY OPERATIONS LLC, Detroit, MI (US)

(72) Inventors: Jing GAO, Rochester, MI (US); Brian J. KOCH, Berkley, MI (US); Zhe LI, Rochester, MI (US); Anne ZHANG, Troy, MI (US)

(73) Assignee: GM GLOBAL TECHNOLOGY OPERATIONS LLC, Detroit, MI (US)

(21) Appl. No.: 18/957,274

(22) Filed: Nov. 22, 2024

(51) Int. Cl. H01M 50/569; H01M 4/02; H01M 4/1397; H01M 4/485; H01M 4/58; H01M 4/62; H01M 50/491

(52) U.S. Cl. CPC H01M 50/569; H01M 4/1397; H01M 4/485; H01M 4/5825; H01M 4/622; H01M 4/625; H01M 4/626; H01M 50/491; H01M 2004/021

(57) ABSTRACT

A reference electrode assembly includes a separator substrate and a reference electrode layer. The separator substrate is porous and electrically insulating. The reference electrode layer is in direct contact with the separator substrate. The reference electrode layer includes an electroactive material, an electrically conductive material, and a binder. The electrically conductive material is intermingled with the electroactive material.

### INTRODUCTION

This section provides background information related to the present disclosure which is not necessarily prior art.

The present disclosure relates to reference electrodes, electrochemical devices including reference electrodes, and method of making reference electrodes.

By way of background, high-energy density, electrochemical cells, such as lithium-ion batteries can be used in a variety of consumer products and vehicles, such as Hybrid Electric Vehicles (HEVs) and Electric Vehicles (EVs). Typical lithium-ion, lithium sulfur, and lithium-lithium symmetrical batteries include a first electrode, a second electrode, an electrolyte material, and a separator. One electrode serves as a positive electrode or cathode and another serves as a negative electrode or anode. A stack of battery cells may be electrically connected to increase overall output.

Rechargeable lithium-ion batteries operate by reversibly passing lithium-ions back and forth between the negative electrode and the positive electrode. A separator and an electrolyte are disposed between the negative and positive electrodes. The electrolyte is suitable for conducting lithium-ions and may be in solid (e.g., solid state diffusion) or liquid form. In certain solid-state batteries, the solid electrolyte may be a layer disposed between positive and negative electrodes that serves as both the electrical separator and the electrolyte. Lithium-ions move from a cathode (positive electrode) to an anode (negative electrode) during charging of the battery, and in the opposite direction when discharging the battery. It may be desirable to perform electrochemical analysis on batteries or certain components of batteries, such as the cathode and the anode.

### SUMMARY

This section provides a general summary of the disclosure, and is not a comprehensive disclosure of its full scope or all of its features.

At least one example embodiment relates to a reference electrode assembly.

In at least one example embodiment, the reference electrode assembly includes a separator substrate and a reference electrode layer. The separator substrate is porous and electrically insulating. The reference electrode layer is in direct contact with the separator substrate. The reference electrode layer includes an electroactive material, an electrically conductive material, and a binder. The electrically conductive material is intermingled with the electroactive material.

In at least one example embodiment, the reference electrode layer is in the form of a single layer.

In at least one example embodiment, the reference electrode layer is in the form of a monolayer.

In at least one example embodiment, the reference electrode assembly is free of a distinct electrically conductive layer.

In at least one example embodiment, the electrically conductive material is in the form of a plurality of electrically conductive fibers.

In at least one example embodiment, the electrically conductive fibers define an average length of greater than or equal to about 0.5 micrometers to less than or equal to about 100 micrometers. The electrically conductive fibers define an average diameter of greater than or equal to about 1 nm to less than or equal to about 1 micrometers.

In at least one example embodiment, the reference electrode assembly has a total porosity of greater than or equal to about 40% to less than or equal to about 70%.

In at least one example embodiment, the reference electrode layer defines a thickness of greater than or equal to about 0.1 micrometers to less than or equal to about 5 micrometers.

the reference electrode layer defines an air permeability of greater than or equal to about 40 Gurley-sec to less than or equal to about 100 Gurley-sec.

In at least one example embodiment, a weight ratio of electrically conductive material to electroactive material in the reference electrode layer is greater than or equal to about 1:1.

In at least one example embodiment, the electrically conductive material is selected from the group consisting of: carbon fibers, carbon nanotubes, graphene, gold, aluminum, platinum, copper, composites thereof, and combinations thereof.

In at least one example embodiment, the electroactive material is selected from the group consisting of: lithium iron phosphate (LiFePO₄), lithium titanate (Li₄Ti₅O₁₂), and a combination thereof. The binder is selected from the group consisting of: carboxymethyl cellulose, styrene butadiene rubber, polyacrylic acid, and combinations thereof.

In at least one example embodiment, the separator substrate defines a thickness of greater than or equal to about 10 micrometers to less than or equal to about 25 micrometers.

In at least one example embodiment, the separator substrate includes a material selected from the group consisting of: polyethylene, polypropylene, a ceramic material, and combinations thereof.

In at least one example embodiment, the separator substrate includes solid-state electrolyte.

In at least one example embodiment, the reference electrode layer covers an area of greater than or equal to about 95% of a superficial surface of the separator substrate.

At least one example embodiment relates to an electrochemical cell.

In at least one example embodiment, the electrochemical cell includes a first electrode, a first current collector, a second electrode, a second current collector, a separator, a reference electrode assembly, and an electrolyte. The first electrode includes a first electroactive material and a first binder. The first current collector includes a first electrically conductive material. The second electrode includes a second electroactive material and a second binder. The second current collector includes a second electrically conductive material. The separator is between the first electrode and the second electrode. The separator is porous and electrically insulating. The reference electrode assembly includes a separator substrate and a reference electrode layer. The separator substrate is porous and electrically insulating. The reference electrode layer is in direct contact with the separator substrate, the reference electrode layer includes a third electroactive material, a third electrically conductive material, and a third binder. The third electrically conductive material is intermingled with the third electroactive material. The electrolyte is in pores of the first electrode, the second electrode, the separator, the separator substrate, and the reference electrode layer.

In at least one example embodiment, the reference electrode layer defines an in-plane resistance of less than or equal to about 300 Ω.

At least one example embodiment relates to a method of making a reference electrode assembly for an electrochemical cell.

In at least one example embodiment, the method includes coating at least a portion of a separator substrate with a reference electrode slurry including a solvent, a binder, an electroactive material, and an electrically conductive material. The separator substrate is porous and electrically insulating. The method further includes drying the reference electrode slurry to create a reference electrode layer in direct contact with the separator substrate. The electroactive material is intermingled with the electrically conductive material in the reference electrode layer.

In at least one example embodiment, the coating includes a process selected from the group consisting of: kiss gravure coating, spray coating, spin coating, airflow laminate coating, and combinations thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an electrochemical device.

FIGS. 2A-2B illustrate electrochemical cells according to at least one example embodiment. FIG. 2A is a perspective view of the electrochemical cell. FIG. 2B is a sectional view of the electrochemical cell.

FIG. 3 is a sectional view of a reference electrode assembly of the electrochemical cell of FIGS. 2A-2B.

FIG. 4 is an enlarged schematic view of a reference electrode layer of the reference electrode assembly of FIG. 3.

FIG. 5 is a flowchart illustrating a method of making a reference electrode assembly according at least one example embodiment.

FIG. 6 is a schematic view illustrating a method of coating a separator substrate with a reference electrode layer in a kiss gravure coating process.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

### General Electrochemical Cell Function, Structure, and Composition

A typical electrochemical cell includes a first electrode, such as a positive electrode or cathode; a second electrode such as a negative electrode or an anode; an electrolyte; and a separator. Often, in a lithium-ion battery pack, electrochemical cells are electrically connected in a stack to increase overall output. Lithium-ion electrochemical cells operate by reversibly passing lithium ions between the negative electrode and the positive electrode. The separator and the electrolyte are disposed between the negative and positive electrodes. The electrolyte is suitable for conducting lithium ions and may be in liquid, gel, or solid form. Lithium ions move from a positive electrode to a negative electrode during charging of the battery, and in the opposite direction when discharging the battery.

Each of the negative and positive electrodes within a stack is typically electrically connected to a current collector (e.g., a metal, such as copper for the negative electrode and aluminum for the positive electrode). During battery usage, the current collectors associated with the two electrodes are connected by an external circuit that allows current generated by electrons to pass between the negative and positive electrodes to compensate for transport of lithium ions.

Electrodes can generally be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators disposed therebetween. While the positive electroactive materials can be used in batteries for primary or single charge use, the resulting batteries generally have desirable cycling properties for secondary battery use over multiple cycling of the cells.

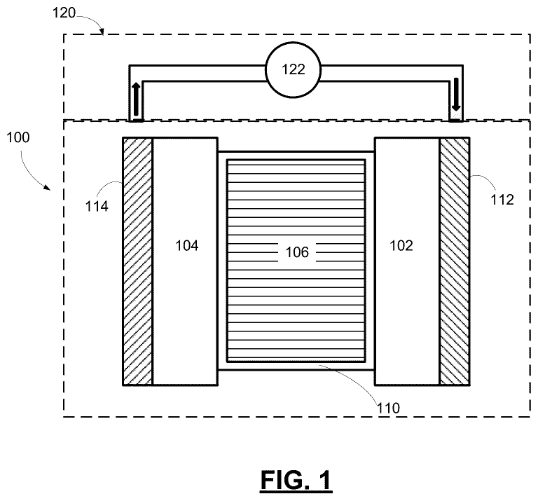

An exemplary schematic illustration of a lithium-ion battery 100 is shown in FIG. 1. The lithium-ion battery 100 includes a negative electrode 102, a positive electrode 104, and a porous separator 106 (e.g., a microporous or nanoporous polymeric separator) disposed between the negative and positive electrodes 102, 104. An electrolyte 110 is disposed between the negative and positive electrodes 102, 104 and in pores of the porous separator 106. The electrolyte 110 may also be present in the negative electrode 102 and positive electrode 104, such as in pores.

A negative electrode current collector 112 may be positioned at or near the negative electrode 102. A positive electrode current collector 114 may be positioned at or near the positive electrode 104. While not shown, the negative electrode current collector 112 and the positive electrode current collector 114 may be coated on one or both sides, as is known in the art. In certain aspects, the current collectors may be coated with an electroactive layer on both sides. The negative electrode current collector 112 and positive electrode current collector 114 respectively collect and move free electrons to and from an external circuit 120. The interruptible external circuit 120 includes a load device 122 that connects the negative electrode 102 (through the negative electrode current collector 112) and the positive electrode 104 (through the positive electrode current collector 114).

The porous separator 106 operates as both an electrical insulator and a mechanical support. More particularly, the porous separator 106 is disposed between the negative electrode 102 and the positive electrode 104 to prevent or reduce physical contact and thus, the occurrence of a short circuit. The porous separator 106, in addition to providing a physical barrier between the two electrodes 102, 104, can provide a minimal resistance path for internal passage of lithium ions (and related anions) during cycling of the lithium ions to facilitate functioning of the lithium-ion battery 100.

The lithium-ion battery 100 can generate an electric current during discharge by way of reversible electrochemical reactions that occur when the external circuit 120 is closed (to electrically connect the negative electrode 102 and the positive electrode 104) when the negative electrode 102 contains a relatively greater quantity of cyclable lithium. The chemical potential difference between the positive electrode 104 and the negative electrode 102 drives electrons produced by the oxidation of lithium (e.g., intercalated/alloyed/plated lithium) at the negative electrode 102 through the external circuit 120 toward the positive electrode 104. Lithium ions, which are also produced at the negative electrode, are concurrently transferred through the electrolyte 110 and porous separator 106 towards the positive electrode 104. The electrons flow through the external circuit 120 and the lithium ions migrate across the porous separator 106 in the electrolyte 110 to intercalate/alloy/plate into a positive electroactive material of the positive electrode 104. The electric current passing through the external circuit 120 can be harnessed and directed through the load device 122 until the lithium in the negative electrode 102 is depleted and the capacity of the lithium-ion battery 100 is diminished.

The lithium-ion battery 100 can be charged or re-energized at any time by connecting an external power source (e.g., charging device) to the lithium-ion battery 100 to reverse the electrochemical reactions that occur during battery discharge. The connection of an external power source to the lithium-ion battery 100 compels the lithium ions at the positive electrode 104 to move back toward the negative electrode 102. The electrons, which flow back towards the negative electrode 102 through the external circuit 120, and the lithium ions, which are carried by the electrolyte 110 across the separator 106 back towards the negative electrode 102, reunite at the negative electrode 102 and replenish it with lithium for consumption during the next battery discharge cycle. As such, each discharge and charge event is considered to be a cycle, where lithium ions are cycled between the positive electrode 104 and negative electrode 102.

The external power source that may be used to charge the lithium-ion battery 100 may vary depending on the size, construction, and particular end-use of the lithium-ion battery 100. Some notable and exemplary external power sources include, but are not limited to, AC power sources, such as an AC wall outlet or a motor vehicle alternator. A converter may be used to change from AC to DC for charging the battery 100.

In many lithium-ion battery configurations, each of the negative electrode current collector 112, negative electrode 102, the separator 106, positive electrode 104, and positive electrode current collector 114 are prepared as relatively thin layers (for example, from several microns to a millimeter or less in thickness) and assembled in layers connected in electrical series and/or parallel arrangement to provide a suitable electrical energy and power package. Furthermore, the lithium-ion battery 100 can include a variety of other components that, while not depicted here, are nonetheless known to those of skill in the art. For instance, the lithium-ion battery 100 may include a casing, gaskets, terminal caps, tabs, battery terminals, and any other conventional components or materials that may be situated within the battery 100, including between or around the negative electrode 102, the positive electrode 104, and/or the separator 106, by way of non-limiting example. As noted above, the size and shape of the lithium-ion battery 100 may vary depending on the particular application for which it is designed. Battery-powered vehicles and handheld consumer electronic devices are two examples where the lithium-ion battery 100 would most likely be designed to different size, capacity, and power-output specifications. The lithium-ion battery 100 may also be connected in series or parallel with other similar lithium-ion cells or batteries to produce a greater voltage output, energy, and/or power as required by the load device 122.

Accordingly, the lithium-ion battery 100 can generate electric current to a load device 122 that can be operatively connected to the external circuit 120. While the load device 122 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 122 may also be a power-generating apparatus that charges the lithium-ion battery 100 for purposes of storing energy. In certain other variations, the electrochemical cell may be a supercapacitor, such as a lithium-ion based supercapacitor.

### Electrolyte

Any appropriate electrolyte 110, whether in solid, liquid, or gel form, capable of conducting lithium ions between the negative electrode 102 and the positive electrode 104 may be used in the lithium-ion battery 100. In certain aspects, the electrolyte 110 may be a non-aqueous liquid electrolyte solution that includes a lithium salt dissolved in an organic solvent or a mixture of organic solvents. Numerous conventional non-aqueous liquid electrolyte 110 solutions may be employed in the lithium-ion battery 100. In certain variations, the electrolyte 110 may include an aqueous solvent (i.e., a water-based solvent) or a hybrid solvent (e.g., an organic solvent including at least 1% water by weight).

Appropriate lithium salts generally have inert anions. Non-limiting examples of lithium salts that may be dissolved in an organic solvent to form the non-aqueous liquid electrolyte solution include lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium difluorooxalatoborate (LiBF₂(C₂O₄)) (LiODFB), lithium tetraphenylborate (LiB(C₆H₅)₄); lithium bis-(oxalate)borate (LiB(C₂O₄)₂) (LiBOB); lithium tetrafluorooxalatophosphate (LiPF₄(C₂O₄)) (LiFOP), lithium nitrate (LiNO₃), lithium hexafluoroarsenate (LiAsF₆); lithium trifluoromethanesulfonate (LiCF₃SO₃); lithium bis(trifluoromethanesulfonimide) (LITFSI) (LiN(CF₃SO₂)₂); lithium fluorosulfonylimide (LiN(FSO₂)₂) (LIFSI); and combinations thereof. In certain variations, the electrolyte 110 may include a 1 M concentration of the lithium salts.

These lithium salts may be dissolved in a variety of organic solvents, such as organic ethers or organic carbonates, by way of example. Organic ethers may include dimethyl ether, glyme (glycol dimethyl ether or dimethoxyethane (DME, e.g., 1,2-dimethoxyethane)), diglyme (diethylene glycol dimethyl ether or bis(2-methoxyethyl) ether), triglyme (tri(ethylene glycol) dimethyl ether), additional chain structure ethers, such as 1-2-diethoxyethane, ethoxymethoxyethane, 1,3-dimethoxypropane (DMP), cyclic ethers, such as tetrahydrofuran, 2-methyltetrahydrofuran, and combinations thereof. In certain variations, the organic ether compound is selected from the group consisting of: tetrahydrofuran, 2-methyl tetrahydrofuran, dioxolane, dimethoxy ethane (DME), diglyme (diethylene glycol dimethyl ether), triglyme (tri(ethylene glycol) dimethyl ether), 1,3-dimethoxypropane (DMP), and combinations thereof. Carbonate-based solvents may include various alkyl carbonates, such as cyclic carbonates (e.g., ethylene carbonate, propylene carbonate, butylene carbonate) and acyclic carbonates (e.g., dimethyl carbonate, diethyl carbonate, ethyl methyl carbonate (EMC)). Ether-based solvents include cyclic ethers (e.g., tetrahydrofuran, 2-methyltetrahydrofuran, 1,3-dioxolane) and chain structure ethers (e.g., 1,2-dimethoxyethane, 1-2-diethoxyethane, ethoxymethoxyethane).

In various aspects, appropriate solvents in addition to those described above may be selected from propylene carbonate, dimethyl carbonate, diethyl carbonate, methyl ethyl carbonate, γ-butyrolactone, dimethyl sulfoxide, acetonitrile, nitromethane and mixtures thereof.

Where the electrolyte is a solid-state electrolyte, it may include a composition selected from the group consisting of: LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or any combination thereof.

### Porous Separator

The porous separator 106 may include, in certain variations, a microporous polymeric separator including a polyolefin, including those made from a homopolymer (derived from a single monomer constituent) or a heteropolymer (derived from more than one monomer constituent), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 106 membranes include CELGARD® 2500 (a monolayer polypropylene separator) and CELGARD® 2340 (a trilayer polypropylene/polyethylene/polypropylene separator) available from Celgard LLC.

When the porous separator 106 is a microporous polymeric separator, it may be a single layer or a multi-layer laminate. For example, in one embodiment, a single layer of the polyolefin may form the entire microporous polymer separator 106. In other aspects, the separator 106 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 106. The microporous polymer separator 106 may also include other polymers alternatively or in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, acrylonitrile-butadiene styrene copolymers (ABS), polystyrene copolymers, polymethylmethacrylate (PMMA), polysiloxane polymers (e.g., polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF-hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, DE)), polyaramides, polyphenylene oxide, cellulosic materials, meso-porous silica, or a combination thereof.

Furthermore, the porous separator 106 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 106 are contemplated, as well as the many manufacturing methods that may be employed to produce such a microporous polymer separator 106.

### Solid-State Electrolyte

In various aspects, the porous separator 106 and the electrolyte 110 may be replaced with a solid-state electrolyte (SSE) that functions as both an electrolyte and a separator. The SSE may be disposed between a positive electrode and a negative electrode. The SSE facilitates transfer of lithium ions, while mechanically separating and providing electrical insulation between the negative and positive electrodes 102, 104. By way of non-limiting example, SSEs may include LiTi₂(PO₄)₃, Li_{1.3}Al_{0.3}Ti_{1.7}(PO₄)₃ (LATP), LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof.

### Positive Electrode

The positive electrode 104 may be formed from or include a lithium-based active material that can undergo lithium intercalation and deintercalation, alloying and dealloying, or plating and stripping, while functioning as the positive terminal of the lithium-ion battery 100. The positive electrode 104 may include a positive electroactive material. Positive electroactive materials may include one or more transition metal cations, such as manganese (Mn), nickel (Ni), cobalt (Co), chromium (Cr), iron (Fe), vanadium (V), and combinations thereof. However, in certain variations, the positive electrode 104 is substantially free of select metal cations, such as nickel (Ni) and cobalt (Co).

Two exemplary common classes of known electroactive materials that can be used to form the positive electrode 104 are lithium transition metal oxides with layered structures and lithium transition metal oxides with spinel phase. For example, in certain instances, the positive electrode 104 may include a spinel-type transition metal oxide, like lithium manganese oxide (Li(₁₊ₓ)Mn(₂₋ₓ)O₄), where x is typically <0.15, including LiMn₂O₄ (LMO) and lithium manganese nickel oxide LiMn_{1.5}Ni_{0.5}O₄ (LMNO). In other instances, the positive electrode 104 may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1 (e.g., LiNi_{0.6}Mn_{0.2}Co_{0.2}O₂, LiNi_{0.8}Mn_{0.1}Co_{0.1}O₂, and/or LiMn_{0.33}Ni_{0.33}Co_{0.33}O₂), a lithium nickel cobalt metal oxide (LiNi_{(1-x-y})CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used. In certain aspects, the positive electrode 104 may include an electroactive material that includes manganese, such as lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide (e.g., LiNi_{0.6}Mn_{0.2}Co_{0.2}O₂, LiNi_{0.8}Mn_{0.1}Co_{0.1}O₂, and/or LiMn_{0.33}Ni_{0.33}Co_{0.33}O₂). In a lithium-sulfur battery, positive electrodes may have elemental sulfur as the active material or a sulfur-containing active material.

The positive electroactive materials may be powder compositions. The positive electroactive materials may be intermingled with an optional electrically conductive material (e.g., electrically-conductive particles) and a polymeric binder. The binder may both hold together the positive electroactive material and provide ionic conductivity to the positive electrode 104. The polymeric binder may include polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, or a combination thereof.

The positive electroactive material loading in the binder can be large, such as greater than about 80% by weight. For example, the binder can be present at a level of greater than or equal to about 1% by weight to less than or equal to about 20% by weight, optionally greater than or equal to about 1% by weight to less than or equal to about 10% by weight, optionally greater than or equal to about 1% to less than or equal to about 8% by weight, optionally greater than or equal to about 1% by weight to less than or equal to about 6% by weight, optionally greater than or equal to about 1% by weight to less than or equal to about 7% by weight, optionally greater than or equal to about 1% by weight to less than or equal to about 5% by weight, or optionally greater than or equal to about 1% by weight to less than or equal to about 3% by weight.

Electrically conductive materials may include graphite, other carbon-based materials, conductive metals, or conductive polymer particles. Carbon-based materials may include, by way of non-limiting example, particles of KETJEN™ black, DENKA™ black, acetylene black, carbon black, and the like. Conductive metal particles may include nickel, gold, silver, copper, aluminum, and the like. Examples of a conductive polymer include polyaniline, polythiophene, polyacetylene, polypyrrole, and the like. In certain aspects, mixtures of electrically conductive materials may be used.

In certain variations, the positive electrode 104 includes the electrically-conductive material in an amount less than or equal to about 15% by weight, optionally less than or equal to about 10% by weight, or optionally greater than or equal to about 0.5% by weight to less than or equal to about 8% by weight. While the supplemental electrically conductive compositions may be described as powders, these materials lose their powder character following incorporation into the electrode where the associated particles of the supplemental electrically conductive material become a component of the resulting electrode structure.

### Negative Electrode

The negative electrode 102 may include a negative electroactive material as a lithium host material capable of functioning as a negative terminal of the lithium-ion battery 100. Common negative electroactive materials include lithium insertion materials or alloy host materials. Such materials can include carbon-based materials, such as lithium-graphite intercalation compounds, lithium-silicon compounds, lithium-tin alloys, or lithium titanate Li₄₊ₓTi₅O₁₂, where 0≤x≤3, such as Li₄Ti₅O₁₂ (LTO).

In certain aspects, the negative electrode 102 may include lithium, and in certain variations metallic lithium and the lithium-ion battery 100. The negative electrode 102 may be a lithium metal electrode (LME). The lithium-ion battery 100 may be a lithium-metal battery or cell. Metallic lithium for use in the negative electrode of a rechargeable battery has various potential advantages, including having the highest theoretical capacity and lowest electrochemical potential. Thus, batteries incorporating lithium-metal anodes can have a higher energy density that can potentially double storage capacity, so that the battery may be half the size, but still last the same amount of time as other lithium-ion batteries.

In certain variations, the negative electrode 102 may optionally include an electrically conductive material, as well as one or more polymeric binder materials to structurally hold the lithium material together. For example, in one embodiment, the negative electrode 102 may include an active material including lithium-metal particles intermingled with a binder material selected from the group consisting of: polyvinylidene difluoride (PVdF), ethylene propylene diene monomer (EPDM) rubber, carboxymethoxyl cellulose (CMC), a nitrile butadiene rubber (NBR), lithium polyacrylate (LiPAA), sodium polyacrylate (NaPAA), sodium alginate, lithium alginate, or a combination thereof. Suitable additional electrically conductive materials may include carbon-based material or a conductive polymer. Carbon-based materials may include by way of example, particles of KETJEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used. The negative electrode 102 may include about 50-100% by weight of an electroactive material (e.g., lithium particles or a lithium foil), optionally greater than or equal to about 30% by weight of an electrically conductive material, and a balance binder.

### Electrode Fabrication

In various aspects, the negative and positive electrodes 102, 104 may be fabricated by mixing the respective electroactive material into a slurry with a polymeric binder compound, a non-aqueous solvent, optionally a plasticizer, and optionally if necessary, electrically conductive particles. The slurry can be mixed or agitated, and then thinly applied to a substrate via a doctor blade and/or slot die coating. The substrate can be a removable substrate or alternatively a functional substrate, such as a current collector (such as a metallic grid or mesh layer) attached to one side of the electrode film. In one variation, heat or radiation can be applied to evaporate the solvent from the electrode film, leaving a solid residue. The electrode film may be further consolidated, where heat and pressure are applied to the film to sinter and calender it. In other variations, the film may be dried at moderate temperature to form self-supporting films. If the substrate is removable, then it is removed from the electrode film that is then further laminated to a current collector. With either type of substrate, the remaining plasticizer may be extracted prior to incorporation into the battery cell. In various aspects, a solid electrode may be formed according to alternative fabrication methods.

### Optional Electrode Surface Coatings

In certain variations, pre-fabricated negative electrodes 102 and positive electrodes 104 formed via the active material slurry casting described above can be directly coated via a vapor coating formation process to form a conformal inorganic-organic composite surface coating, as described further below. Thus, one or more exposed regions of the pre-fabricated negative electrodes including the electroactive material can be coated to minimize or prevent reaction of the electrode materials with components within the electrochemical cell to minimize or prevent lithium metal dendrite formation on the surfaces of negative electrode materials when incorporated into the electrochemical cell. In other variations, a plurality of particles including an electroactive material, like lithium metal, can be coated with an inorganic-organic composite surface coating. Then, the coated electroactive particles can be used in the active material slurry to form the negative electrode, as described above.

### Current Collectors

The negative and positive electrodes 102, 104 are generally associated with the respective negative and positive electrode current collectors 112, 114 to facilitate the flow of electrons between the electrode and the external circuit 120. The current collectors 112, 114 are electrically conductive and can include metal, such as a metal foil, a metal grid or screen, or expanded metal. Expanded metal current collectors refer to metal grids with a greater thickness such that a greater amount of electrode material is placed within the metal grid. By way of non-limiting example, electrically-conductive materials include copper, nickel, aluminum, stainless steel, titanium, gold, alloys thereof, or combinations thereof.

The positive electrode current collector 114 may be formed from aluminum or any other appropriate electrically conductive material known to those of skill in the art. The negative electrode current collector 112 may be formed from copper or any other appropriate electrically conductive material known to those of skill in the art. Negative electrode current collectors do not typically include aluminum because aluminum reacts with lithium, thereby causing large volume expansion and contraction. The drastic volume changes may lead to fracture and/or pulverization of the current collector.

### Analysis of Electrochemical Cells

It may be desirable to perform electrochemical analysis on electrodes. Electrochemical analysis may produce calibrations for control systems in HEVs and EVs pertaining to fast charge, lithium plating, state of charge, and power estimation, for example. The electrodes may be analyzed by providing a reference electrode in an electrochemical cell including positive and negative electrodes. The reference electrode enables monitoring of individual positive and negative electrode potentials as the cell is being cycled. Potentials may be monitored in a lab setting or during real-time use of a system including the electrochemical cell. For example, potentials may be detected during operation of a vehicle, as part of regular vehicle diagnostics. Detected potentials can be used in vehicle control algorithms to improve cell performance, such as by raising anode potential to decrease lithium plating.

Some reference electrodes are nonporous and may therefore create a “shadow effect” during cell cycling by blocking ion transport in the region of the reference electrode, thereby inhibiting cell performance. Another type of reference electrode, which may be referred to as a “dot-like reference electrode,” is porous and relatively small. Electrochemical cells including dot-like reference electrodes may suffer from reduced cycle life and uneven current distribution, resulting in possible cell damage, such as lithium plating.

In various aspects, the present disclosure provides a reference electrode assembly including a separator substrate and a reference electrode layer in direct contact with the separator substrate. The reference electrode layer includes an electroactive material intermingled with an electrically conductive material. The electrically conductive material may form a conductive network throughout the entire reference electrode layer such that it acts as a current collector. The reference electrode assembly may therefore be free of a distinct current collector layer. The reference electrode layer may be present as a single layer (e.g., a monolayer). The present disclosure also provides an electrochemical cell including the reference electrode assembly. The reference electrode assembly may be used for high fidelity in situ potential measurement of individual negative and positive electrodes in the electrochemical cell.

The present disclosure also provides methods of making a reference electrode assembly. The methods may include formation of the reference electrode layer in a kiss gravure coating process. In certain aspects, compared to a multilayer reference electrode assembly, such as a reference electrode assembly including a distinct current collector, the present reference electrode assembly may have reduced manufacturing complexity. For example, the reference electrode assembly may be prepared in a single coating process.

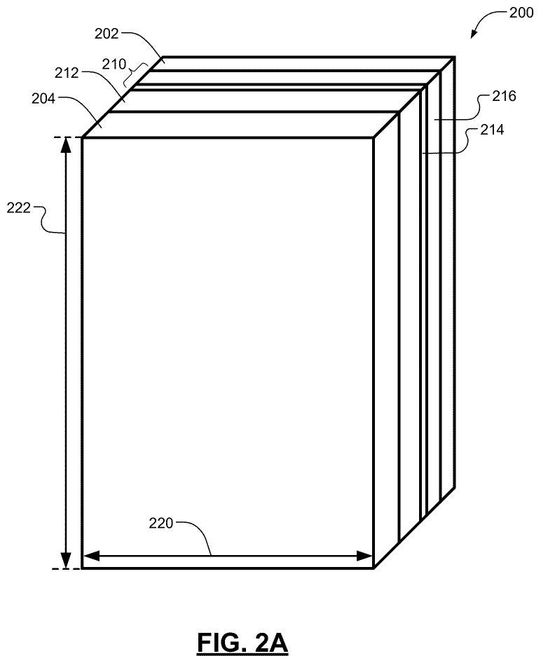

With reference to FIGS. 2A-2B, an electrochemical device or cell 200 according to various aspects of the present disclosure is provided. The electrochemical device 200 includes a first or negative electrode 202 and a second or positive electrode 204. The negative electrode 202 is coupled to a negative electrode current collector 206. The positive electrode 204 is electrically connected to a positive electrode current collector 208.

A reference electrode assembly or component 210 and a separator component 212 are disposed between the negative and positive electrodes 202, 204. The negative and positive electrodes 202, 204, the reference electrode assembly 210, and the separator component 212 may be imbibed with an electrolyte (not shown). The separator component 212 may be disposed between the positive electrode 204 and the reference electrode assembly 210.

The reference electrode assembly 210 reference electrode layer or film 214 (also referred to as an “electroactive layer or film”) and a separator substrate or layer or reference electrode separator 216. In at least one example embodiment, the reference electrode assembly 210 is oriented in the electrochemical device 200 such that the separator substrate 216 is disposed adjacent to the negative electrode 202 and the reference electrode layer 214 is disposed adjacent to the separator component 212. The reference electrode layer may be directly between the separator component 212 and the separator substrate 216. The separator substrate 216 may be directly between the negative electrode 202 and the reference electrode layer 214. In at least one other example embodiment, an electrochemical device may be arranged such a separator layer is disposed adjacent to a positive electrode and an electroactive layer is disposed adjacent to a separator component.

In at least one example embodiment, the reference electrode assembly 210 may have a similar size and shape as the negative and positive electrodes 202, 204. For example, the reference electrode assembly 210, negative electrode 202, and positive electrode 204 may all share a common first dimension or width 220 and second dimension or height 222. The reference electrode layer 214 may also share the same width 220 and height 222 as the negative and positive electrodes 202, 204.

With reference to FIG. 2B, first measurement device, such as a first voltage meter 230 may be electrically connected to the negative and positive electrodes 202, 204 via the negative and positive electrode current collectors 206, 208 to detect a potential between the negative and positive electrodes 202, 204. A second measurement device, such as a second voltage meter 232 may be electrically connected to the negative electrode 202 and the reference electrode layer 214 via the negative electrode current collectors 206 and the reference electrode layer 214 to detect a potential difference between the negative electrode 202 and the reference electrode layer 214.

An electrical lead for the second voltage meter 232 may be connected anywhere that is accessible on the reference electrode layer 214 without the need for a distinct tab due to the presence of the conductive network throughout the entire reference electrode layer 214. Because characteristics of the reference electrode layer 214 are known, the measurement by the second voltage meter 232 ultimately provides individual potential of the negative electrode 202. Individual potential of the positive electrode 204 can be determined from the above measurements. In at least one example embodiment, the electrochemical device including the reference electrode assembly 210 is used for in situ electrode potential measurement.

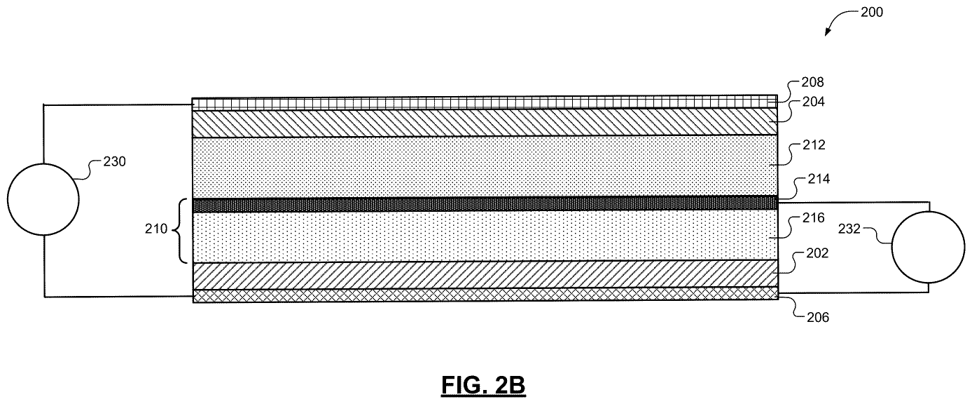

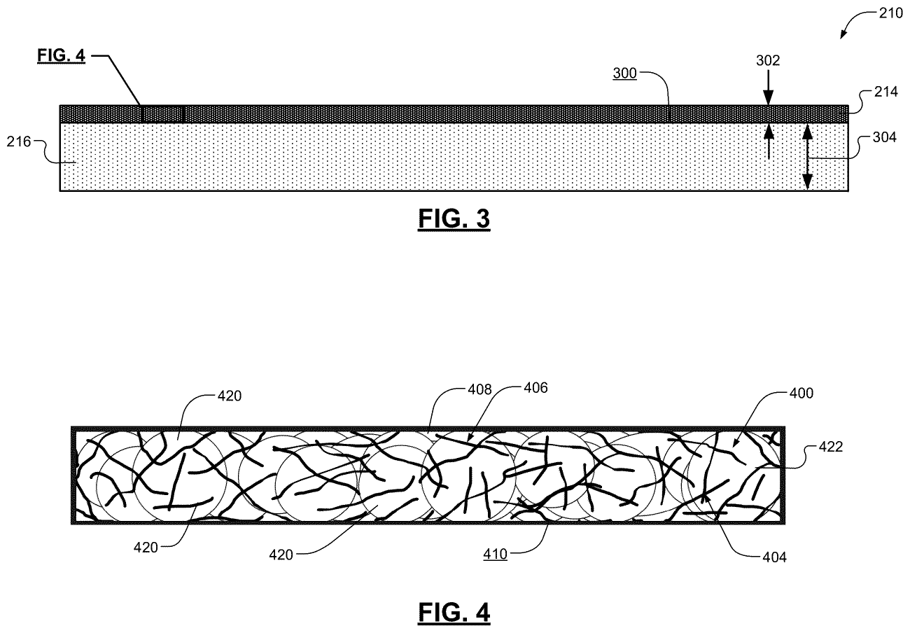

With reference to FIG. 3, the reference electrode layer 214 may be in direct contact with the separator substrate 216. In at least one example embodiment, the reference electrode layer 214 is in the form of a single layer. As used herein, “single layer” means a layer having substantially the same composition throughout its thickness. The single layer includes an admixture of materials. The materials are not present as distinct multiple layers, but are instead intermingled with one another through an entire thickness of the single layer, as will be described in greater detail below in the discussion of FIG. 4. In at least one example embodiment, as shown in FIG. 4, the single layer is a monolayer. As used herein, “monolayer” means a single layer that is one electroactive material particle thick. Thus, a thickness of the monolayer is the substantially the same as a diameter of the electroactive material particles.

In at least one example embodiment, the reference electrode assembly 210 is free of a distinct electrically conductive layer (e.g., current connector). The reference electrode assembly 210 may be free of a distinct current collector when an electrically conductive material of the reference electrode layer 214 is present in an amount and/or format such that it forms an electrically conductive network throughout the reference electrode layer 214. The network may extend across an entire length, width, and thickness of the reference electrode layer 214.

In at least one other example embodiment, a reference electrode assembly further includes one or more electrically conductive layers. An electrically conductive layer may be present on either side of a reference electrode layer (i.e., such that the electrically conductive layer is between a separator substrate and a reference electrode layer, or such that a reference electrode layer is between a separator substrate and an electrically conductive layer). The electrically conductive layer may include a carbon-based material, carbon fiber, carbon nanotube, graphene, gold, aluminum, platinum, copper, any composite thereof, or any combination thereof.

In at least one example embodiment, the reference electrode layer 214 covers all or a substantial portion of an area of an entire superficial surface 300 of the separator substrate 216. As used herein, “superficial surface” means an outermost or uppermost surface. The “superficial surface” is smaller than the actual surface, which would include portions of the surface defining pores that are located away from the outermost or uppermost surface. In at least one example embodiment, the reference electrode layer 214 covers substantially the entire area of the superficial surface 300 of the separator substrate 216. Thus, the superficial surface 216 be substantially free of uncoated portions. Pore surfaces of the separator substrate 300 that are not part of the superficial surface 300 may be substantially uncoated or free of direct contact with the reference electrode layer 214. That is, the electroactive material 400 generally does not extend into the pores to block the pores.

In at least one example embodiment, the reference electrode layer 214 covers greater than or equal to about 50% of the area of the entire superficial surface 300 of the separator substrate 216 (e.g., greater than or equal to about 55%, greater than or equal to about 60%, greater than or equal to about 65%, greater than or equal to about 70%, greater than or equal to about 75%, greater than or equal to about 80%, greater than or equal to about 85%, greater than or equal to about 90%, greater than or equal to about 92%, greater than or equal to about 95%, greater than or equal to about 96%, greater than or equal to about 97%, greater than or equal to about 98%, or greater than or equal to about 99%). In at least one example embodiment, the reference electrode layer 214 covers less than or equal to 100% of the superficial surface 300 of the separator substrate 216 (e.g., less than or equal to about 99%, less than or equal to about 98%, less than or equal to about 97%, less than or equal to about 96%, less than or equal to about 95% less than or equal to about 92%, less than or equal to about 90%, less than or equal to about 85%, less than or equal to about 80%, less than or equal to about 75%, less than or equal to about 70%, less than or equal to about 65%, less than or equal to about 60%, or less than or equal to about 55%).

The reference electrode assembly 210 is porous such that ions can pass through the reference electrode assembly 210 during cycling of the electrochemical device 200. In at least one example embodiment, the reference electrode assembly 210 has a total porosity of greater than or equal to about 30% (e.g., greater than or equal to about 35%, greater than or equal to about 40%, greater than or equal to about 45%, greater than or equal to about 50%, greater than or equal to about 55%, greater than or equal to about 60%, greater than or equal to about 65%, greater than or equal to about 70%, or greater than or equal to about 75%). The reference electrode assembly 210 may have a total porosity of less than or equal to about 80% (e.g., less than or equal to about 75%, less than or equal to about 70%, less than or equal to about 65%, less than or equal to about 60%, less than or equal to about 55%, less than or equal to about 50%, less than or equal to about 45%, less than or equal to about 40%, or less than or equal to about 35%).

In at least one example embodiment, the reference electrode layer 214 has a first porosity of greater than or equal to about 30% (e.g., greater than or equal to about 35%, greater than or equal to about 40%, greater than or equal to about 45%, greater than or equal to about 50%, greater than or equal to about 55%, greater than or equal to about 60%, greater than or equal to about 65%, greater than or equal to about 70%, or greater than or equal to about 75%). The first porosity of the reference electrode layer 214 may be less than or equal to about 80% (e.g., less than or equal to about 75%, less than or equal to about 70%, less than or equal to about 65%, less than or equal to about 60%, less than or equal to about 55%, less than or equal to about 50%, less than or equal to about 45%, less than or equal to about 40%, or less than or equal to about 35%). In at least one example embodiment, the separator substrate 216 has a second porosity of greater than or equal to about 30% (e.g., greater than or equal to about 35%, greater than or equal to about 40%, greater than or equal to about 45%, greater than or equal to about 50%, greater than or equal to about 55%, greater than or equal to about 60%, greater than or equal to about 65%, greater than or equal to about 70%, or greater than or equal to about 75%). The second porosity of the separator substrate 216 may be less than or equal to about 80% (e.g., less than or equal to about 75%, less than or equal to about 70%, less than or equal to about 65%, less than or equal to about 60%, less than or equal to about 55%, less than or equal to about 50%, less than or equal to about 45%, less than or equal to about 40%, or less than or equal to about 35%). In at least one example embodiment, the first porosity is greater than or equal to the second porosity such that the reference electrode layer 214 does not inhibit the passage of ions through the reference electrode assembly 210. In at least one example embodiment, the first and second porosities are the same.

In at least one example embodiment, the reference electrode layer 214 defines a first thickness 302. The first thickness 302 is greater than or equal to about 0.1 micrometers (μm) (e.g., greater than or equal to about 0.2 μm, greater than or equal to about 0.3 μm, greater than or equal to about 0.4 μm, greater than or equal to about 0.5 μm, greater than or equal to about 0.75 μm, greater than or equal to about 1 μm, greater than or equal to about 1.5 μm, greater than or equal to about 2 μm, greater than or equal to about 2.5 μm, greater than or equal to about 3 μm, greater than or equal to about 3.5 μm, greater than or equal to about 4 μm, greater than or equal to about 4.5 μm, greater than or equal to about 5 μm, greater than or equal to about 6 μm, greater than or equal to about 7 μm, greater than or equal to about 8 μm, or greater than or equal to about 9 μm). The first thickness 302 may be less than or equal to about 10 μm (e.g., less than or equal to about 9 μm, less than or equal to about 8 μm, less than or equal to about 7 μm, less than or equal to about 6 μm, less than or equal to about 5 μm, less than or equal to about 4.5 μm, less than or equal to about 4 μm, less than or equal to about 4 μm, less than or equal to about 3.5 μm, less than or equal to about 3 μm, less than or equal to about 2.5 μm, less than or equal to about 2 μm, less than or equal to about 1.5 μm, less than or equal to about 1 μm, less than or equal to about 0.75 μm, less than or equal to about 0.5 μm, less than or equal to about 0.4 μm, less than or equal to about 0.3 μm, or less than or equal to about 0.2 μm).

In at least one example embodiment, the separator substrate 216 defines a second thickness 304. The second thickness 304 may be greater than or equal to about 5 μm (e.g., greater than or equal to about 7.5 μm, greater than or equal to about 10 μm, greater than or equal to about 12.5 μm, greater than or equal to about 15 μm, greater than or equal to about 17.5 μm, greater than or equal to about 20 μm, or greater than or equal to about 22.2 μm). The second thickness 304 may be less than or equal to about 25 μm (e.g., less than or equal to about 22.5 μm, less than or equal to about 20 μm, less than or equal to about 17.5 μm, less than or equal to about 15 μm, less than or equal to about 12.5 μm, less than or equal to about 10 μm, or less than or equal to about 7.5 μm).

In at least one example embodiment, the separator substrate 216 includes polypropylene (PP), polyethylene (PE), a ceramic material, or any combination thereof. The separator substrate 216 may include a single layer or multiple layers (e.g., a PP layer and a PE layer). In at least one example embodiment, the separator substrate 216 includes a coated separator (e.g., a PP and/or PE separator having a ceramic coating). In at least one example embodiment, the separator substrate 216 is a solid-state electrolyte, such as those discussed above. A solid-state electrolyte may include a layer of electrically-insulating, ionically-conductive material thereon.

In at least one example embodiment, the reference electrode assembly 210 has an air permeability of greater than or equal to about 40 Gurley-sec (e.g., greater than or equal to about 50 Gurley-sec, greater than or equal to about 60 Gurley-sec, greater than or equal to about 70 Gurley-sec, greater than or equal to about 80 Gurley-sec, or greater than or equal to about 90 Gurley-sec). The air permeability may be less than or equal to about 100 Gurley-sec (e.g., less than or equal to about 90 Gurley-sec, less than or equal to about 80 Gurley-sec, less than or equal to about 70 Gurley-sec, less than or equal to about 60 Gurley-sec, or less than or equal to about 50 Gurley-sec).

As used herein, “in-plane resistance” means a resistance of the reference electrode layer 214 when the reference electrode assembly 210 is in the electrochemical device 200 (shown in FIGS. 2A-2B). The in-plane resistance is dependent, in part, on a size of the reference electrode layer 214. In at least one example embodiment, the reference electrode layer 214 has an in-plane resistance of less than or equal to about 300 Ω (e.g., less than or equal to about 275 Ω, less than or equal to about 250 Ω, less than or equal to about 225 Ω, less than or equal to about 200 Ω, less than or equal to about 175 Ω, less than or equal to about 150 Ω, less than or equal to about 125 Ω, or less than or equal to about 100 Ω).

With reference to FIG. 4, the electroactive layer 214 include an electroactive material 400, a binder (not shown), and an electrically conductive material 404. The electroactive material 400 and the electrically conductive material 404 are admixed and/or intermingled. The electrically conductive material 404 may form an electrically conductive network or web 406 through the entire electroactive layer 214. The electroactive material 400 may be in pores 408 defined by the electrically conductive network 406. Substantially all of the electroactive material 400 may be in electrical contact with the electrically conductive network 406. The electrically conductive network 406 may be exposed along a surface 410 of the reference electrode layer 214 to facilitate the connection of electrical leads.

In at least one example embodiment, the electrically conductive material 404 may be present in the reference electrode layer 214 in a higher amount than electrically conductive additives in a positive or negative electrode to form the electrically conductive network 406. In at least one example embodiment, a weight ratio of the electrically conductive material 404 to the electroactive material 400 may be greater than or equal to about 20:80 (e.g., greater than or equal to about 25:75, greater than or equal to about 30:70, greater than or equal to about 35:65, greater than or equal to about 40:60, greater than or equal to about 45:55, greater than or equal to about 50:50 (i.e., 1:1), greater than or equal to about 55:45, greater than or equal to about 60:40, greater than or equal to about 65:35, greater than or equal to about 70:30, or greater than or equal to about 75:25). The weight ratio of the electrically conductive material 404 to the electroactive material 400 may be less than or equal to about 80:20 (e.g., less than or equal to about 75:25, less than or equal to about 70:30, less than or equal to about 65:35, less than or equal to about 60:40, less than or equal to about 55:45, less than or equal to about 50:50 (i.e., 1:1), less than or equal to about 45:55, less than or equal to about 40:60, less than or equal to about 35:65, less than or equal to about 30:70, or less than or equal to about 25:75).

In at least one example embodiment, the electroactive material 400 may be in the form of a plurality of particles 420. The plurality of particles 420 of electroactive material 400 may define an average size (i.e., diameter) greater than or equal to about 0.1 micrometers (μm) (e.g., greater than or equal to about 0.2 μm, greater than or equal to about 0.3 μm, greater than or equal to about 0.4 μm, greater than or equal to about 0.5 μm, greater than or equal to about 0.75 μm, greater than or equal to about 1 μm, greater than or equal to about 1.5 μm, greater than or equal to about 2 μm, greater than or equal to about 2.5 μm, greater than or equal to about 3 μm, greater than or equal to about 3.5 μm, greater than or equal to about 4 μm, or greater than or equal to about 4.5 μm). The average size of the plurality of particles 420 may be less than or equal to about 5 μm (e.g., less than or equal to about 4.5 μm, less than or equal to about 4 μm, less than or equal to about 4 μm, less than or equal to about 3.5 μm, less than or equal to about 3 μm, less than or equal to about 2.5 μm, less than or equal to about 2 μm, less than or equal to about 1.5 μm, less than or equal to about 1 μm, less than or equal to about 0.75 μm, less than or equal to about 0.5 μm, less than or equal to about 0.4 μm, less than or equal to about 0.3 μm, or less than or equal to about 0.2 μm). In at least one example embodiment, the particles 420 are larger than pores of the separator substrate 216 such that the particles 420 do not enter the pores.

In at least one example embodiment, the reference electrode layer 214 includes the electroactive material 400 in an amount greater than or equal to about 15 weight percent (e.g., greater than or equal to about 20 weight percent, greater than or equal to about 25 weight percent, greater than or equal to about 30 weight percent, greater than or equal to about 35 weight percent, greater than or equal to about 40 weight percent, greater than or equal to about 45 weight percent, greater than or equal to about 50 weight percent, greater than or equal to about 55 weight percent, greater than or equal to about 60 weight percent, greater than or equal to about 65 weight percent, or greater than or equal to about 70 weight percent). The reference electrode layer 214 may include the electroactive material 400 in an amount less than or equal to about 80 weight percent (e.g., less than or equal to about 75 weight percent, less than or equal to about 70 weight percent, less than or equal to about 65 weight percent, less than or equal to about 60 weight percent, less than or equal to about 55 weight percent, less than or equal to about 50 weight percent, less than or equal to about 45 weight percent, less than or equal to about 40 weight percent, less than or equal to about 35 weight percent, less than or equal to about 30 weight percent, less than or equal to about 25 weight percent, or less than or equal to about 20 weight percent).

The electroactive material 400 may include a material having a constant or substantially constant voltage regardless of state of charge. In at least one example embodiment, the electroactive material 400 may include lithium iron phosphate, lithium titanate, lithium aluminum, or a metal oxide, or any combination thereof.

In at least one example embodiment, the electrically conductive material includes a carbon material, gold, aluminum, platinum, copper, a composite thereof, or any combination thereof. The carbon material may include carbon nanotubes, carbon fibers, graphene, or any combination thereof.

In at least one example embodiment, the electrically conductive material 404 may in the form of a plurality of fibers 422 or other elongated structures. The fibers or elongated structures may have an average length of greater than or equal to about 0.5 μm (e.g., greater than or equal to about 1 μm, greater than or equal to about 2 μm, greater than or equal to about 5 μm, greater than or equal to about 10 μm, greater than or equal to about 15 μm, greater than or equal to about 20 μm, greater than or equal to about 25 μm, greater than or equal to about 30 μm, greater than or equal to about 40 μm, greater than or equal to about 50 μm, greater than or equal to about 60 μm, greater than or equal to about 70 μm, greater than or equal to about 80 μm, or greater than or equal to about 90 μm). The average length may be less than or equal to about 100 μm (e.g., less than or equal to about 90 μm, less than or equal to about 80 μm, less than or equal to about 70 μm, less than or equal to about 60 μm, less than or equal to about 50 μm, less than or equal to about 40 μm, less than or equal to about 30 μm, less than or equal to about 25 μm, less than or equal to about 20 μm, less than or equal to about 15 μm, less than or equal to about 10 μm, less than or equal to about 5 μm, less than or equal to about 2 μm, or less than or equal to about 1 μm). The fibers 422 may have an average diameter of greater than or equal to about 1 nm (e.g., greater than or equal to about 10 nm, greater than or equal to about 50 nm, greater than or equal to about 100 nm, greater than or equal to about 200 nm, greater than or equal to about 300 nm, greater than or equal to about 400 nm, greater than or equal to about 500 nm, greater than or equal to about 600 nm, greater than or equal to about 700 nm, greater than or equal to about 800 nm, or greater than or equal to about 900 nm). The average diameter may be less than or equal to about 1 μm (e.g., less than or equal to about 900 nm, less than or equal to about 800 nm, less than or equal to about 700 nm, less than or equal to about 600 nm, less than or equal to about 500 nm, less than or equal to about 400 nm, less than or equal to about 300 nm, less than or equal to about 200 nm, less than or equal to about 100 nm, less than or equal to about 50 nm, or less than or equal to about 10 nm).

In at least one example embodiment, the reference electrode layer 214 includes the electrically conductive material 404 in an amount greater than or equal to about 15 weight percent (e.g., greater than or equal to about 20 weight percent, greater than or equal to about 25 weight percent, greater than or equal to about 30 weight percent, greater than or equal to about 35 weight percent, greater than or equal to about 40 weight percent, greater than or equal to about 45 weight percent, greater than or equal to about 50 weight percent, greater than or equal to about 55 weight percent, greater than or equal to about 60 weight percent, greater than or equal to about 65 weight percent, or greater than or equal to about 70 weight percent). The reference electrode layer 214 may include the electrically conductive material 404 in an amount less than or equal to about 80 weight percent (e.g., less than or equal to about 75 weight percent, less than or equal to about 70 weight percent, less than or equal to about 65 weight percent, less than or equal to about 60 weight percent, less than or equal to about 55 weight percent, less than or equal to about 50 weight percent, less than or equal to about 45 weight percent, less than or equal to about 40 weight percent, less than or equal to about 35 weight percent, less than or equal to about 30 weight percent, less than or equal to about 25 weight percent, or less than or equal to about 20 weight percent).

The binder may be formed from materials such as those described above in conjunction with the negative and positive electrodes 102, 104 of FIG. 1. In certain aspects, the binder may be a water-soluble binder. The binder may include carboxymethyl cellulose (CMC), styrene butadiene rubber (SBR), polyvinyl alcohol (PVA), or any combination thereof. The reference electrode layer 214 may include the binder in an amount greater than or equal to about 10 weight percent (e.g., greater than or equal to about 15 weight percent, or greater than or equal to about 20 weight percent). The reference electrode layer 214 may include the binder in an amount less than or equal to about 25 weight percent (e.g., less than or equal to about 20 weight percent, or less than or equal to about 15 weight percent).

In at least one example embodiment, the reference electrode layer 214 has a loading of greater than or equal to about 1 g/m² on the separator substrate 216 (e.g., greater than or equal to about 2 g/m², greater than or equal to about 3 g/m², greater than or equal to about 4 g/m², greater than or equal to about 5 g/m², greater than or equal to about 6 g/m², greater than or equal to about 7 g/m², greater than or equal to about 8 g/m², or greater than or equal to about 9 g/m²). The loading of the reference electrode layer 214 may be less than or equal to about 10 g/m² (e.g., less than or equal to about 9 g/m², less than or equal to about 8 g/m², less than or equal to about 7 g/m², less than or equal to about 6 g/m², less than or equal to about 5 g/m², less than or equal to about 4 g/m², less than or equal to about 3 g/m², or less than or equal to about 2 g/m²).

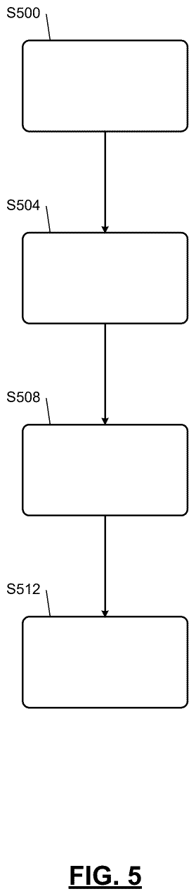

In at least one example embodiment, as shown in FIG. 5, a method of making a reference electrode assembly generally includes preparing a reference electrode slurry at S500; preparing an electrode precursor by coating a separator substrate with a reference electrode slurry at S504; forming a reference electrode assembly by drying the reference electrode slurry at S508; and optionally creating a plurality of reference electrode assemblies at S512.

At S500, the method includes preparing a reference electrode slurry. Preparing the reference electrode slurry includes combining a solvent, an electroactive material, a binder, and an electrically conductive material. The solvent may include water, an alcohol, N-methyl-2-pyrrolidone (NMP), or any combination thereof. The slurry may include the solvent at greater than or equal to about 40 weight percent (e.g., greater than or equal to about 45 weight percent, greater than or equal to about 50 weight percent, greater than or equal to about 55 weight percent, greater than or equal to about 60 weight percent, greater than or equal to about 65 weight percent, greater than or equal to about 70 weight percent, greater than or equal to about 75 weight percent, greater than or equal to about 80 weight percent, greater than or equal to about 85 weight percent, greater than or equal to about 90 weight percent, or greater than or equal to about 95 weight percent). The slurry may include the solvent at less than or equal to about 98 weight percent (e.g., less than or equal to about 95 weight percent, less than or equal to about 90 weight percent, less than or equal to about 85 weight percent, less than or equal to about 80 weight percent, less than or equal to about 75 weight percent, less than or equal to about 70 weight percent, less than or equal to about 65 weight percent, less than or equal to about 60 weight percent, less than or equal to about 55 weight percent, less than or equal to about 50 weight percent, or less than or equal to about 45 weight percent).

At S504, the method includes preparing the electrode precursor. Preparing the electrode precursor includes coating the reference electrode slurry on a separator substrate. The coating may be performed by kiss gravure coating, spray coating, spin coating, air flow laminate coating, any combination thereof, or other coating methods. Spin coating and air flow laminate coating may be performed according to the methods described in U.S. Pat. No. 11,374,268 to Gao et al., filed on Sep. 9, 2019, which is incorporated by reference in its entirety.

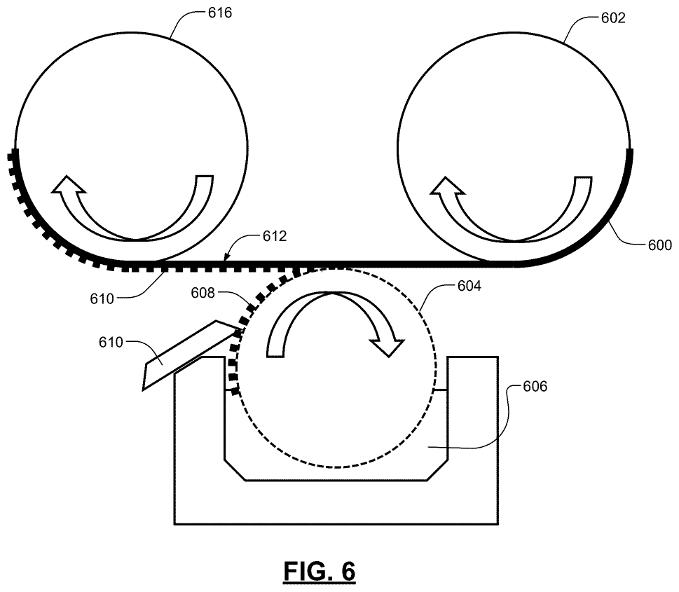

As shown in FIG. 6, kiss gravure coating includes providing a continuous separator substrate 600, such as from a first roller 602. The continuous separator substrate conveyed toward a gravure roller 604. The gravure roller 604 rotates through a bath 606 containing a reference electrode slurry. During rotations, the gravure roller 604 picks up a layer 608 of the reference electrode slurry. In at least one example embodiment, the gravure roller 604 includes a plurality of grooves to facilitate collection of the reference electrode slurry. The layer 608 is rotated past a doctor blade 610 facilitate transfer of a consistent amount of reference electrode slurry. Although FIG. 6 illustrates the gravure roller 604 as rotating in the same direction and the first roller 602, in at least one other example embodiment, a gravure roller rotates in an opposite direction than a first roller and a doctor blade is on an opposite side of a bath. As the gravure roller 604 continues to rotate, the layer 608 contacts the separator substrate 600 and at least a portion 612 is applied to the separator substrate 600 to form a reference electrode precursor 614.

The reference electrode precursor 614 is dried, as will be described in greater detail below, and may be wound around a second roller 616. The reference electrode precursor 614 may be dried (e.g., by airflow) before being wound around the second roller 616. Steps S504 and S508 may be performed in a continuous, roll-to-roll process.

At S508, the method includes forming the reference electrode assembly by drying the reference electrode precursor. Drying includes removing at least a portion of the solvent from the slurry. In at least one example embodiment, drying include removing substantially all of the solvent from the reference electrode slurry. Drying may be conducted at ambient temperature (e.g., by circulation or flow of ambient air), or above-ambient temperature (e.g., by circulation or flow of heated air or in an oven).

At S512, the method optionally includes creating a plurality of reference electrode assemblies. Creating a plurality of reference electrode assemblies may include subdividing the reference electrode formed at S508, such as when it is formed in a large-scale, continuous process. Creating the plurality of reference electrode assemblies may include mechanical cutting (e.g., die cutting), laser cutting, or any combination thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A reference electrode assembly comprising:
a separator substrate, the separator substrate being porous and electrically insulating; and
a reference electrode layer in direct contact with the separator substrate, the reference electrode layer including:
an electroactive material,
an electrically conductive material intermingled with the electroactive material, and
a binder.

2. The reference electrode assembly of claim 1, wherein the reference electrode layer is in the form of a single layer.

3. The reference electrode assembly of claim 1, wherein the reference electrode layer is in the form of a monolayer.

4. The reference electrode assembly of claim 1, wherein the reference electrode assembly is free of a distinct electrically conductive layer.

5. The reference electrode assembly of claim 1, wherein the electrically conductive material is in the form of a plurality of electrically conductive fibers.

6. The reference electrode assembly of claim 5, wherein
the electrically conductive fibers define an average length of greater than or equal to about 0.5 micrometers to less than or equal to about 100 micrometers, and
the electrically conductive fibers define an average diameter of greater than or equal to about 1 nanometer to less than or equal to about 1 micrometer.

7. The reference electrode assembly of claim 1, wherein the reference electrode assembly has a total porosity of greater than or equal to about 40% to less than or equal to about 70%.

8. The reference electrode assembly of claim 1, wherein the reference electrode layer defines a thickness of greater than or equal to about 0.1 micrometers to less than or equal to about 5 micrometers.

9. The reference electrode assembly of claim 1, wherein the reference electrode layer defines an air permeability of greater than or equal to about 40 Gurley-sec to less than or equal to about 100 Gurley-sec.

10. The reference electrode assembly of claim 1, wherein a weight ratio of electrically conductive material to electroactive material in the reference electrode layer is greater than or equal to about 1:1.

11. The reference electrode assembly of claim 1, wherein the electrically conductive material is selected from the group consisting of: carbon fibers, carbon nanotubes, graphene, gold, aluminum, platinum, copper, any composite thereof, and combinations thereof.

12. The reference electrode assembly of claim 1, wherein
the electroactive material is selected from the group consisting of: lithium iron phosphate (LiFePO₄), lithium titanate (Li₄Ti₅O₁₂), and a combinations thereof, and
the binder is selected from the group consisting of: carboxymethyl cellulose, styrene butadiene rubber, polyacrylic acid, and combinations thereof.

13. The reference electrode assembly of claim 1, wherein the separator substrate defines a thickness of greater than or equal to about 10 micrometers to less than or equal to about 25 micrometers.

14. The reference electrode assembly of claim 1, wherein the separator substrate includes a material selected from the group consisting of: polyethylene, polypropylene, a ceramic material, and combinations thereof.

15. The reference electrode assembly of claim 1, wherein the separator substrate includes a solid-state electrolyte.

16. The reference electrode assembly of claim 1, wherein the reference electrode layer covers an area of greater than or equal to about 95% of a superficial surface of the separator substrate.

17. An electrochemical cell comprising:
a first electrode including a first electroactive material and a first binder;
a first current collector including a first electrically conductive material;
a second electrode including a second electroactive material and a second binder;
a second current collector including a second electrically conductive material;
a separator disposed between the first electrode and the second electrode, the separator being porous and electrically insulating;
a reference electrode assembly including,
a separator substrate, the separator substrate being porous and electrically insulating, and
a reference electrode layer in direct contact with the separator substrate, the reference electrode layer including,
a third electroactive material,
a third electrically conductive material intermingled with the third electroactive material, and
a third binder; and
an electrolyte disposed in pores of the first electrode, the second electrode, the separator, the separator substrate, and the reference electrode layer.

18. The electrochemical cell of claim 17, wherein the reference electrode layer defines an in-plane resistance of less than or equal to about 300 Ω.

19. A method of making a reference electrode assembly for an electrochemical cell, the method comprising:
coating at least a portion of a separator substrate with a reference electrode slurry including a solvent, a binder, an electroactive material, and an electrically conductive material, the separator substrate being porous and electrically insulating; and
drying the reference electrode slurry to create a reference electrode layer in direct contact with the separator substrate, the electroactive material intermingled with the electrically conductive material in the reference electrode layer.

20. The method of claim 19, wherein the coating includes a process selected from the group consisting of: kiss gravure coating, spray coating, spin coating, airflow laminate coating, and combinations thereof.
